(19) United States
(12) Patent Application Publication
(10) Pub. No.: US 2014/0318256 A1
(43) Pub. Date: Oct. 30, 2014

(54) ACOUSTIC SENSOR FOR MEASURING A LINEAR MOVEMENT

(71) Applicant: AREVA, Courbevoie (FR)

(72) Inventors: Jocelyn Perisse, Lyon (FR); Jean-Reynald Mace, Palaiseau (FR); Patrick Fayet, Lachassagne (FR); Thierry Mazoyer, Massieux (FR); Christophe Thirard, Ecully (FR); Pascal Vouagner, Fleurieu Sur Saone (FR)

(21) Appl. No.: 14/362,835

(22) PCT Filed: Dec. 5, 2012
(86) PCT No.: PCT/EP2012/074440

§ 371 Date: Jun. 4, 2014

(30) Foreign Application Priority Data
Dec. 6, 2011 (FR) 1161190

(51) Int. Cl. G01P 13/00; G01B 17/00

(52) U.S. Cl. CPC G01P 13/00; G01B 17/00
USPC 73/627

(57) ABSTRACT

An acoustic sensor for measuring the linear movement of an internal structure of a nuclear reactor using sound waves, including: an electro-acoustic transducer capable of emitting sound waves; and a waveguide capable of guiding the sound waves emitted by the transducer toward a measurement area of the internal structure, wherein the waveguide is capable of guiding the reflected wave and the waveguide is secured to the measurement area and arranged so as to be capable of extending or retracting in accordance with the movement of the internal structure of the nuclear reactor.

### TECHNICAL FIELD

This invention relates to an acoustic sensor for measuring the linear movement using sound waves.

The invention has a particularly interesting application in the field of nuclear reactors, in particular for measuring the movements of the internal structures of a nuclear reactor, such as for example the structure referred to as “core support” intended to receive the nuclear fuel.

### PRIOR ART

During the years of service of a nuclear reactor, it is required to be able to provide controls as well as inspections of the services and of the internal structures of the reactor vessel. It is therefore important to be able to monitor the static deformation of the major members such as the core support structure subjected to substantial temperature and pressure stresses.

Solutions are known that make it possible to measure the deformation and the movements of the internal structures of a reactor vessel. However, regardless of the method of measurement used (for example capacitive, optical, resistive, electromagnetic, etc.), the setting in place of a sensor inside the reactor vessel is required. The sensor is therefore subjected to very severe radiation and temperature conditions that impose a design of the sensors that is particularly complex and expensive which must comply with regulations in terms of nuclear safety for the construction of equipment.

The document “Acoustic sensors for measuring linear deformation under radiation conditions. A. V. Zelenchuk, AtomnayaEnergiya, Vol. 51, No. 3, pp. 167-171, September 1981” describes an acoustic sensor for measuring a linear deformation, associated with a method for measuring, that can be used in conditions of radiation and temperature such as are present in the vessel of a nuclear reactor.

The document describes a device for measuring formed by a first waveguide adapted to guide the emission sound wave and by a second waveguide adapted to guide the reflected sound wave. The two waveguides communicate at the level of one of their ends by the arrangement of a groove on second waveguide. A mobile piston, positioned in contact with the part to be measured, modifies the opening of the groove in accordance with the movement of the part to be measured as such modifying the characteristics of the reflected wave in accordance with the linear movement of the part. Such a device is relatively expensive and complex to produce in particular in light of the number of elements required to produce the device.

On the other hand, the document also describes a method for measuring comprising a step of calibrating the device consisting in taking a measurement of a reference signal without closing off the groove by the piston in order to carry out a calibration of the sensor. Such a method of calibration does not make it possible to obtain measurements that are sufficiently precise, as the calibration is carried out periodically and the measurement conditions can vary between each calibration period, in particular when the sensor is used in an environment subjected to substantial temperature gradients along the measurement device.

### DESCRIPTION OF THE INVENTION

The invention has for objective to overcome the aforementioned disadvantages by proposing an acoustic sensor for the measurement of a linear movement making it possible to take precise measurements regardless of the environment wherein the sensor is used and in particular in an environment subjected to severe temperature conditions, typically of a magnitude of 400° C.

For this purpose, the invention proposes an acoustic sensor for measuring a linear movement of an internal structure of a nuclear reactor using sound waves comprising:
an electro-acoustic transducer capable of emitting said sound wave;
a waveguide capable of guiding said sound wave emitted by said transducer toward a measurement area of the internal structure;
said acoustic sensor being characterised in that said waveguide is capable of guiding the reflected wave; said waveguide is secured to said measurement area of the internal structure and arranged so as to be able to extend or retract in accordance with the movement of said internal structure of the nuclear reactor.

The sensor according to the invention uses a single waveguide for the propagation of the emitted wave and of the reflected wave making it possible as such to minimise the number of parts used for the production of the sensor and to minimise the number of parts which are subjected to substantial stress in substantial temperature and radiation conditions.

The acoustic sensor for measuring a linear movement according to the invention can also have one or several of the characteristics hereinbelow taken individually or according to any technically permissible combinations:
said waveguide is formed by a plurality of sections of which two consecutive sections have a different diameter so as to be able to take a measurement under a temperature gradient;
said waveguide is formed by three sections: a connecting section comprising said transducer, an intermediate standard section and a measuring section secured to said measurement area;
the standard section has a diameter less than the connecting sections and the measuring section located on either side of said standard section;
said measuring section comprises means adapted to extend or retract said waveguide in accordance with the movement of the measurement area;
said means are formed by a metal bellows;
said means are formed by a piston secured to said measurement area and sliding inside the measuring section;
said means are formed by a cylindrical tube comprising a bottom secured to said measurement area, said cylindrical tube being adapted to cooperate by sliding with said measuring section;
said electro-acoustic transducer is a piezoelectric transducer.

The invention also has for object a method for measuring a linear movement of an internal structure positioned in the vessel .of a nuclear reactor using an acoustic sensor according to the invention characterised in that it comprises a step of positioning said sensor in such a way that said electro-acoustic transducer, capable of emitting said sound wave and of receiving the reflected wave, is positioned outside of the vessel of said reactor; and in that said waveguide, capable of guiding said sound wave emitted by said transducer toward a measurement area and capable of guiding the reflected wave, is positioned in the vessel of said reactor.

Advantageously, the method for measuring according to the invention comprises a step of calibrating the acoustic sensor carried out simultaneously during the measurement of the linear movement of the internal structure.

Advantageously, the method for measuring according to the invention comprises a step of analysing the reflection of said emitted wave in such a way as to determine the movement of the internal structure.

### BRIEF DESCRIPTION OF THE FIGURES

Other characteristics and advantages of the invention shall appear more clearly in the description that is provided hereinbelow, for the purposes of information and in no way restrictive, in reference to the annexed figures, among which:

FIG. 1 is a diagrammatical representation of a first embodiment of an acoustic sensor for measuring a linear movement of a core support structure of a nuclear reactor;

FIG. 2 is a diagrammatical representation of a second embodiment of an acoustic sensor for measuring a linear movement of a core support structure of a nuclear reactor;

FIG. 3 is a diagrammatical representation of a third embodiment of an acoustic sensor for measuring a linear movement of a core support structure of a nuclear reactor;

FIG. 4 is a graph showing a history of the emitted and reflected signals recorded by the acoustic sensor according to the invention during the measuring of a linear movement.

For increased clarity, identical or similar elements are marked with identical reference signs in all of the figures.

### DETAILED DESCRIPTION OF AT LEAST ONE EMBODIMENT

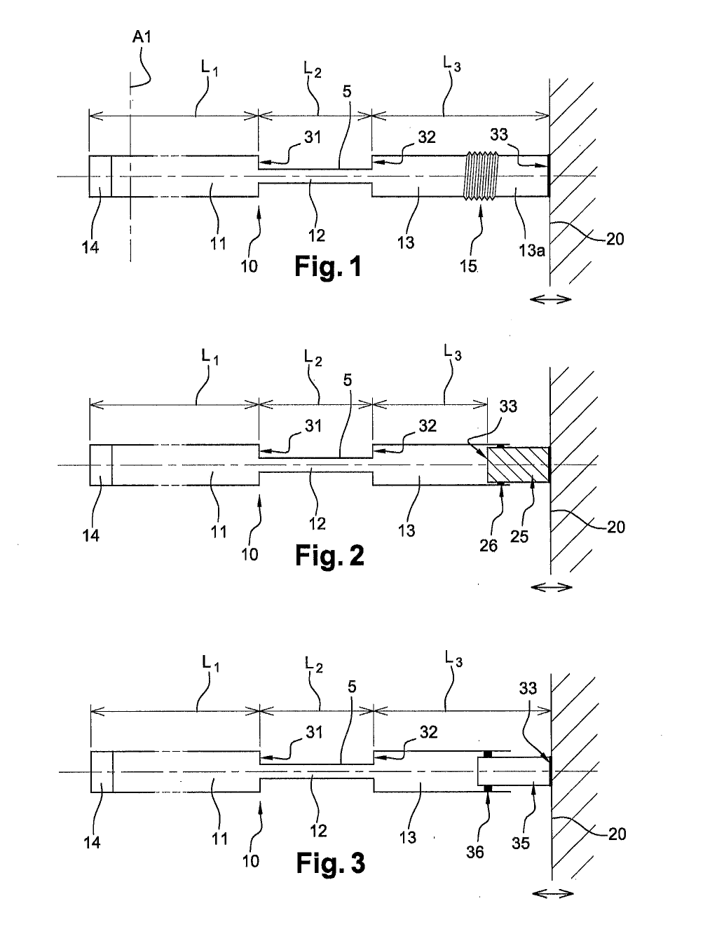

FIG. 1 shows a first embodiment of an acoustic sensor making it possible to measure a linear movement of a structure 20 present in the vessel of a nuclear reactor, such as for example a core support structure intended to receive fuel rods.

The acoustic sensor 10 according to the invention is formed by a waveguide 5 constituted by:
a first section 11, referred to as connecting section, of length L1 comprising a portion integrated into the vessel of the reactor and another portion located outside of the vessel, with the delimitation of the vessel being materialised in FIG. 1 by the axis as a dotted line A1;
a second section 12, referred to as standard section 12, of length L2;
a third section 13, referred to as measuring section, of variable length L3 secured to the part to be measured 20.

The three sections thus form a continuous waveguide 5 capable of propagating a sound wave.

The acoustic sensor 10 further comprises;
a piezoelectric transducer 14 located on the end of the connecting section 11 positioned outside of the vessel, with the transducer 14 able to emit and receive the acoustic signals propagating inside the waveguide 5;
means 15 arranged on the measuring section 13 and adapted to extend or retract the length of the section 13 in accordance with the movement of the structure 20 that defines the measurement area of the acoustic sensor 10.

In this first embodiment, the means 15 adapted to extend or retract the waveguide 5 in accordance with the movement of the structure 20 are formed by a metal bellows that makes it possible to decouple in stiffness the portion of the measuring section 13a, secured to the structure 20, in relation to the rest of the waveguide 5. As such, the means 15 make it possible to adapt the shape and/or the length of the waveguide 5 in accordance with the movement of the structure 20. The movement of the structure 20 modifies the length L3 of the measuring section 13 and modifying as such the response time of the reflected signal on the bottom 33 of the waveguide 5 travelling a distance in the waveguide 5 which is according to the movement of the structure 20.

The waveguide 5 is formed by a sealed stainless steel tube filled with a neutral gas. The diameter of the sections 11, 12, 13 and the frequency of the sound wave are defined in such a way as to fulfil the conditions of propagation of a sound wave in a waveguide.

The standard section 12 located between the connecting section 11 and the measuring section 13 has a diameter less than the sections 11 and 13 located on either side of the standard section 12. The difference in diameter between the various successive sections forms geometrical cracks 31, 32 on the junction of the various sections 11, 12, 13. These cracks 31, 32 as well as the bottom 33 of the waveguide 5 as such form acoustic reflectors located inside the waveguide 5.

These reflectors 31, 32 are positioned at a distance L1 and a distance L1+L2 from the transducer 14. As these distances are known and fixed during the measurement phase, the signals reflected by these reflectors will make it possible to carry out a calibration of the acoustic sensor and will also be used for deducing the linear movement of the structure 20,

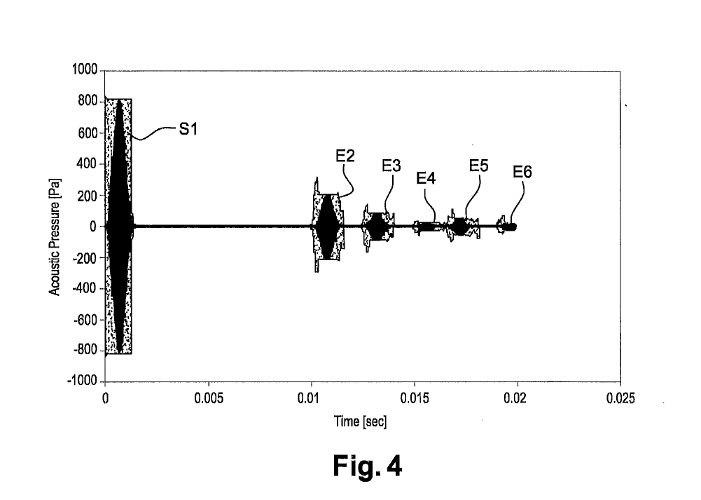

FIG. 4 shows an example of the results obtained during a measurement of a linear movement of a structure using the acoustic sensor 10 according to the invention.

The graph shows the emission signal S1 emitted by the transducer 14 as well as the echoes E2, E3, E4, E5, E6 recorded by the transducer 14. Each means the reflection of the emission sound wave S1 of which the amplitude and the delay in relation to the emission wave are sufficient to be detected by the transducer 14. The analysis of the echoes by signal processing methods make it possible as such to determine the value of the movement at the end of the acoustic sensor 10 secured to the structure 20.

The three echoes E3, E4 and E5 make it possible to take the measurement of the movement and the echoes E3 and E4 make it possible to calibrate the sensor during the taking of the measurement simultaneously,

Indeed, the echoes E3 and E4 make it possible to determine the rapidity of the sound wave propagating in the waveguide 5 during the taking of the measurement.

Thanks to the particular geometry of the acoustic sensor according to the invention, the calibration of the sensor 10 and the measurement of the movement are carried out using the same sound wave emitted by the transducer. The sensor according to the invention as such makes it possible to determine for each measurement, the rapidity of the sound wave in the waveguide 5.

As such, the acoustic sensor according to the invention can be used in severe temperature conditions, such as for example in the internal vessel of a nuclear reactor with substantial temperature gradients along the waveguide. Indeed, during the production of the measurement the temperature gradients along the waveguide 5 modifying the rapidity of the wave are taken into account during the measurement by an automatic and systematic calibration of the acoustic sensor.

As such, the acoustic sensor according to the invention can be applied perfectly to the measuring of a linear movement of an internal structure of a nuclear reactor. Indeed, the acoustic sensor according to the invention can be positioned in a nuclear reactor vessel without incidence on the precision of the measurement. The electronic portion that is sensitive to the radiation and temperature conditions (i.e. the transducer) is offset outside of the severe environment, i.e. outside of the vessel in our application example.

Such a sensor makes it possible to obtain, regardless of the temperature conditions, a precision of less than a millimetre and preferably less than 0.5 mm for a movement of a magnitude of a millimetre.

In a second embodiment of the invention shown in FIG. 2, the means arranged on the measuring section 13 and adapted to extend or retract the measuring section 13 in accordance with the movement of the structure 20 are formed by a piston 25 sliding inside the section 13. In this embodiment, the piston 25 is secured to the structure in such a way that the movement of the structure 20 varies the position of the face 33 and consequently the reflector formed by the bottom of the waveguide 5.

Means of sealing 26 are arranged between the piston 25 and the section 13 in such a way as to render the waveguide 5 sealed from the external environment.

In a third embodiment of the invention shown in FIG. 3, the means arranged on the measuring section 13 and adapted to extend or retract the measuring section 13 in accordance with the movement of the structure 20 are formed by a hollow cylindrical tube 35 sliding inside the section 13. The cylindrical tube 35 comprises a bottom 33 secured onto the structure 20 in such a way that the movement of the structure 20 modifies the position of the reflector formed by the bottom 33 of the cylindrical tube 35.

Means of sealing 36 are arranged between the cylindrical tube and the section 13 in such a way as to render the waveguide 5 sealed from the external environment.

According to an alternative (not shown) of this embodiment, the cylindrical tube comprises a diameter greater than the third measuring, section 13 in such a way that the cylindrical tube slides outside of the measuring section.

The invention has been particularly described for the measurement of a movement of an internal structure of a nuclear reactor, such as a core support structure; however, the invention can also be applied to the measurement of a movement of any other type of part and can be applied to other fields of use.

The acoustic sensor according to the invention is particularly well suited for measuring a linear movement in an environment subjected to substantial temperatures or temperature gradients.

The other advantages of the invention are in particular the following:
measurement electronics offset outside of the severe environment:
robustness of the acoustic sensor;
maintenance of the acoustic sensor facilitated by the positioning of the measurement electronics sensitive to the radiation in a zone with low radiation;
substantial resistance of the waveguide to the seal;
externalisation of the sensitive portion (measurement electronics) outside of the environment subjected to severe conditions of temperature, radiation, etc.

1. Acoustic sensor for measuring a linear movement of an internal structure of a nuclear reactor using sound waves comprising:
an electro-acoustic transducer capable of emitting a sound wave;
a waveguide capable of guiding said sound wave emitted by said transducer toward a measurement area of the internal structure;
wherein said waveguide is capable of guiding a reflected wave, said waveguide being secured to said measurement area and arranged in such a way as to be able to extend or retract in accordance to with the movement of said internal structure of the nuclear reactor.

2. The acoustic sensor for measuring a linear movement of an internal structure of a nuclear reactor using sound waves as claimed in claim 1, wherein said waveguide is formed by a plurality of sections of which two successive sections have a different diameter so as to be able to take a measurement under a temperature gradient.

3. The acoustic sensor for measuring a linear movement of an internal structure of a nuclear reactor using sound waves according to claim 1, wherein said waveguide is formed by three sections: a connecting section comprising said transducer, an intermediate standard section and a measuring section secured to said internal structure.

4. The acoustic sensor for measuring a linear movement of an internal structure of a nuclear reactor using sound waves as claimed in claim 3, wherein the standard section has a diameter less than that of the connecting section and the measuring section located on either side of said standard section.

5. The acoustic sensor for measuring a linear movement of an internal structure of a nuclear reactor using sound waves according to claim 1, wherein said measuring section comprises means adapted to extend or retract said waveguide in accordance with the movement of the measurement area.

6. The acoustic sensor for measuring a linear movement of an internal structure of a nuclear reactor using sound waves as claimed in claim 5, wherein said means are formed by a metal bellows.

7. The acoustic sensor for measuring a linear movement of an internal structure of a nuclear reactor using sound waves according to claim 5, wherein said means are formed by a piston secured to said measurement area and sliding inside the measuring section.

8. The acoustic sensor for measuring a linear movement of an internal structure of a nuclear reactor using sound waves according to claim 5, wherein said means are formed by a cylindrical tube comprising a bottom secured to said measurement area, said cylindrical tube being adapted to cooperate by sliding with said measuring section.

9. The acoustic sensor for measuring a linear movement of an internal structure of a nuclear reactor using sound waves according to claim 1, wherein said electro-acoustic transducer is a piezoelectric transducer.

10. Method for measuring a linear movement of an internal structure positioned in the vessel of a nuclear reactor using an acoustic sensor according to claim 1, comprising positioning said sensor in such a way that said electro-acoustic transducer, capable of emitting said sound wave and of receiving the reflected wave, is positioned outside of the vessel of said reactor; and said waveguide, capable of guiding said sound wave emitted by said transducer toward a measurement area and capable of guiding the reflected wave, is positioned in the vessel of said reactor.

11. The method for measuring a linear movement of an internal structure positioned in the vessel of a nuclear reactor according to claim 10, comprising calibrating the acoustic sensor simultaneously during the measurement of the linear movement of the internal structure.

12. The method for measuring a linear movement of an internal structure positioned in the vessel of a nuclear reactor according to claim 10, comprising analysing the reflection of said emitted wave in such a way as to determine the movement of the internal structure.
